(19) United States
(12) Patent Application Publication
(10) Pub. No.: US 2023/0360125 A1
(43) Pub. Date: Nov. 9, 2023

(54) SYSTEMS AND METHODS FOR RECONSTRUCTING AND COMPUTING DYNAMIC PIECEWISE FUNCTIONS ON DISTRIBUTED CONSENSUS SYSTEMS

(71) Applicant: Superluminal Labs Ltd., London (GB)

(72) Inventors: Ariah Aram KLAGES-MUNDT, Winona, MN (US); Steffen SCHULDENZUCKER, Frankfurt am Main (DE)

(21) Appl. No.: 17/933,087

(22) Filed: Sep. 17, 2022

Related U.S. Application Data
(63) Continuation-in-part of application No. 17/738,319, filed on May 6, 2022.

(51) Int. Cl. G06Q 40/04; G06F 17/11

(52) U.S. Cl. CPC G06Q 40/04; G06F 17/11

(57) ABSTRACT

A system for implementing a high-flexibility constant ellipse market maker (“HF-CEMM”) of a pool having reserves of a first asset class and a second asset class. The system is configured to: receive a one or more of initialization parameters including a current reserve state (x, y) of the pool, wherein x and y respectively represent a current reserve of the first asset class and the second asset class; and generate an ellipse fitted to the one or more of initialization parameters, wherein an arc of the ellipse corresponds to a trading curve, the trading curve coinciding with the current reserve state (x, y). The system can be further configured to: receive a transaction request; match a pair of Δx and Δy such that a reserve state (x+Δx, y−Δy) coincides with the trading curve; and disburse Δy of the second asset class in exchange for Δx of the first asset class.

### CROSS-REFERENCE TO RELATED APPLICATIONS

This application is a continuation-in-part of U.S. application Ser. No. 17/738,319, entitled “Systems and Methods for Reconstructing and Computing Dynamic Piecewise Function on Distributed Consensus System,” and filed on May 6, 2022. The contents of that application are hereby incorporated by reference in their entirety.

### TECHNICAL FIELD

The present disclosure relates generally to performing computations on peer-to-peer systems, and more specifically, on systems and methods for implementing a high-flexibility constant ellipse market maker (“HF-CEMM”).

### BACKGROUND

An automated market maker (“AMM”) is a pool of two or more assets that encodes functionality for an external user to swap one asset for another in the pool according to a pricing rule. AMMs are typically implemented as smart contracts (i.e., programs that run on blockchain virtual machines and adhere to mathematical formulae). In addition to swapping functionality, AMMs allow users to contribute to the pool by adding assets (i.e., adding liquidity), which can be removed later according to the pricing rule (i.e., removing liquidity). Contributing liquidity to an AMM pool (i.e., being a liquidity provider) involves committing assets to a portfolio rule within the pool where the rebalancing of that portfolio rule is outsourced to traders and arbitrageurs who interact with the pool and adjust its algorithmic pricing to match the market pricing of assets within the pool.

One AMM that has been proposed is a constant ellipse market maker (“CEMM”) introduced in two papers by Yongge Wang. The CEMM is an AMM in which the pricing rule prices trades between two assets along an ellipse. See Yongge Wang, Automated Market Makers for Decentralized Finance (DeFi) (2020), https://arxiv.org/abs/2009.01676 (“Wang 2020”); see also Yongge Wang, Implementing Automated Market Makers with Constant Circle 2021, https://arxiv.org/abs/2103.03699 (“Wang 2021”). In other words, the CEMM designates a portion of the ellipse as a trading curve.

Wang presented two variants of the CEMM in his papers. In Wang 2020, the paper described a type of CEMM at a mathematical level. The proposed CEMM is severely limited in the way that the trading curve can be configured. Specifically, the described ellipse can only have rotational angle of 45° and symmetric price bounds—that is, the lower price bound of the trading curve (i.e., price at a point where the trading curve intersects the y-axis) is inversely related to the upper price bound (i.e., price at the point where the trading curve intersects the x-axis). The price at a given point on the trading curve is characterized by the negative slope of a line tangential to the trading curve at the given point. Wang 2021 proposed a variant CEMM. However, the CEMM proposed in Wang 2021 is also subject to significant configurational limitations. Specifically, the proposed CEMM only supports special case configurations where the orientation of the ellipse is set to 0° or 90° (i.e., the orientation of the major axis of the ellipse must either be parallel to the x-axis or the y-axis). Furthermore, Wang 2021 describes an ellipse that only allows a fixed ellipse center and only supports the trading curve having symmetric price bounds. To fit the ellipse to a set of price bounds, Wang 2021 applies a scaling factor to adjust the size of the ellipse.

The CEMM equations presented in Wang 2020 and Wang 2021 have been analyzed mathematically and the described code has been executed in a simulation environment. Through that analysis, the present disclosure has identified several fundamental shortcomings with the CEMM proposed by Wang that severely limit its ability to model realistic pricing conditions. Furthermore, Wang's proposed methodology, when executed using ordinary fixed point arithmetic operations outside the limited configurations allowed by Wang 2020 and Wang 2021, would produce significant and exploitable rounding errors, thus rendering Wang's CEMMs unsuitable for conducting large volume or large value transactions. The above-described limitations are fundamental and inherent to the mathematical structures underpinning Wang's CEMM, which cannot be overcome without taking a new approach.

### SUMMARY

As briefly described in the background section, the present disclosure has identified two fundamental shortcomings with the constant ellipse market maker (CEMM) described by Wang, which limits its practicability and usefulness in modeling real-world pricing conditions. First, as the present disclosure will elucidate, the CEMM described by Wang lacks flexibility. Due to configurational limitations, the ellipse in Wang's CEMM can only be arranged in a few specific ways, therefore limiting the ability for the ellipse to model a variety of real-world pricing conditions. Second, as the present disclosure will also elucidate, the CEMM described by Wang is not able to produce high-accuracy computations outside the limited configurations allowed by Wang 2020 and Wang 2021. If adapted outside of these limited configurations, the computations produced by Wang's CEMM for large volume or large value transactions are likely to produce significant and exploitable rounding errors, leaving gaps in security that can be exploited by bad actors. Further, the above shortcomings are inherent to the mathematical structures used by Wang's CEMMs and cannot be easily overcome.

In view of the foregoing, the present disclosure adopts a new approach and proposes a high-flexibility constant ellipse market maker (“HF-CEMM”). According to the present disclosure the HF-CEMM generates and fits an ellipse based on a set of design conditions (i.e., initialization parameters). The HF-CEMM generates and fits the ellipse by simultaneously solving for a set of fitting parameters that modify at least one of the shape, rotational angle, offset position, and radius of the ellipse to satisfy the initialization parameters. The parameters described herein allows the HF-CEMM to have at least four degrees of freedom, thus enabling the HF-CEMM to fit to a variety of design conditions. Additionally, the present disclosure teaches the implementation of an algorithm which allows transactions on the HF-CEMM to yield high- accuracy results even for large volume and large value transactions. Furthermore, the HF-CEMM can be applied in systems with limitations on computing capability, be it limited computing resources (e.g., power, memory, processing speed, etc.) or computing infrastructure that require consensus (e.g., blockchain systems).

According to some implementations of the present disclosure, a system for implementing a high-flexibility constant ellipse market maker (“HF-CEMM”) of a pool having reserves of a first asset class and a second asset class is provided. The system includes a non-transitory computer-readable medium storing computer-executable instructions thereon such that when the instructions are executed, the system is configured to: (a) receive a one or more of initialization parameters including a current reserve state (x, y) of the pool, wherein x and y respectively represent a current reserve of the first asset class and the second asset class; and (b) generate an ellipse fitted to the one or more of initialization parameters, wherein an arc of the ellipse corresponds to a trading curve, the trading curve coinciding with the current reserve state (x, y). The system can be further configured to: (c) receive a transaction that specifies at least one of Δx and Δy, wherein Δx is an offer amount of the first asset class and Δy is a disburse amount of the second asset class; (d) match a value pair for Δx and Δy such that a reserve state (x+Δx, y−Δy) coincides with the trading curve and Δy is non-negative; and (e) responsive to matching the value pair of Δx and Δy, disburse Δy amount of the second asset class in exchange for Δx amount of the first asset class.

According to some implementations of the present disclosure, a method for implementing a high-flexibility constant ellipse market maker (“HF-CEMM”) of a pool having reserves of a first asset class and a second asset class. The method includes: (a) receiving a one or more of initialization parameters including a current reserve state (x, y) of the pool, wherein x and y respectively represent a current reserve of the first asset class and the second asset class; and (b) generating an ellipse fitted to the one or more of initialization parameters, wherein an arc of the ellipse corresponds to a trading curve, the trading curve coinciding with the current reserve state (x, y). The method can further include: (c) receiving a transaction that specifies at least one of Δx and Δy, wherein Δx is an offer amount of the first asset class and Δy is a disburse amount of the second asset class; (d) matching a value pair for Δx and Δy such that a reserve state (x+Δx, y−Δy) coincides with the trading curve and Δy is non-negative; and (e) responsive to matching the value pair of Δx and Δy, disbursing Δy amount of the second asset class in exchange for Δx amount of the first asset class.

According to some implements of the present disclosure, a system for allocating transaction value on a high-flexibility constant ellipse market maker (“HF-CEMM”) of a pool having reserves of a first asset class and a second asset class. The system includes a non-transitory computer-readable medium storing computer-executable instructions thereon such that when the instructions are executed, the system is configured to: (a) provide an ellipse based on the one or more of initialization parameters, wherein an arc of the ellipse corresponds to a trading curve, the trading curve coinciding a current reserve state (x, y) of the pool, wherein x and y respectively represent a current reserve of the first asset class and the second asset class; (b) receive one or more allocation parameters including a transaction retainment factor δ and a CEMM retainment factor γ; (c) receive, from a first user, a transaction that specifies at least one of Δx and Δy, wherein Δx is an offer amount of the first asset class and Δy is a disburse amount of the second asset class; (d) match a value pair for Δx and Δy such that a reserve state (x+Δx′, y−Δy) coincides with the trading curve and Δy is non-negative, wherein Δx′ is a product of Δx·(1−δ); and (e) responsive to determining the value pair of Ax and Ay, (i) allocate an amount γ·δ·Δx of the first asset class to the CEMM; (ii) allocate Δy amount of the second asset class to the first user in exchange for Δx amount of the first asset class; and (iii) allocate (1−γ)·γ·Δx amount of the first asset class to a second user (e.g., a liquidity provider).

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 illustrates a system for performing computation in a distributed environment, according to some implementations of the present disclosure.

FIGS. 2A through 2C illustrate a process for constructing and fitting an ellipse to a set of initialization parameters, according to some implementations of the present disclosure.

FIGS. 3A and 3B illustrate swap performed on a trading curve generated from an arc of the ellipse, according to some implementations of the present disclosure.

FIG. 4 is a flow diagram depicting example operations for generating an ellipse fitted to one or more initialization parameters, according to some implementations of the present disclosure.

FIG. 5 is a flow diagram depicting example operations for trading a first asset class for a second asset class using a trade curve, according to some implementations of the present disclosure.

FIG. 6 is a flow diagram depicting example operations of a transaction in which the matching operation takes into account allocating part of the transaction value to one or more second users (e.g., a protocol) and the one or more liquidity providers, according to some implementations of the present disclosure.

The present disclosure is susceptible of various modifications and alternative forms, and some representative embodiments have been shown by way of example in the drawings and will be described in detail herein. It should be understood, however, that the inventive aspects are not limited to the particular forms illustrated in the drawings. Rather, the disclosure is to cover all modifications, equivalents, and alternatives falling within the spirit and scope of the disclosure as defined by the appended claims.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

As described above in the background section, Wang 2020 and Wang 2021 developed a theoretical concept of using an ellipse as a trading curve for exchanging two or more assets. However, the present disclosure identified at least two shortcomings with Wang's proposed CEMM that limits its practicability and usefulness in modeling real-world pricing conditions.

First, the CEMM described by Wang is inflexible due to having configurational limitations that only allow the ellipse to be arranged in a few specific ways, therefore limiting the ability of the ellipse to model a variety of real-world pricing conditions. The configurational limitations in Wang's CEMMs stem from the mathematical structure of the considered equations rather than the design choices. Specifically, it is apparent from equation 8 in Wang 2020 that any ellipse resulting from equation 8 must be rotated by 45° and has a lower price bound and an upper price bound that are inversely related to each other. Thus, the foregoing configurational limitations cannot be easily circumvented. Wang 2021 proposed a variant CEMM. However, the revised CEMM is also subject to significant configurational limitations. Specifically, the proposed CEMM only supports special case configurations where the orientation of the ellipse is set to 0° or 90° (i.e., the orientation of the major axis of the ellipse must either be parallel to the x-axis or the y-axis).

Another problem stemming from the configurational limitations of Wang 2021 is that a highly desirable region along the ellipse for use as a trading curve is rendered practically unusable. As previously described, the trading price at a given point on the trading curve is represented by the negative slope of a line tangential to the trading curve at the given point. Because the slope of the trading curve changes most gradually near the region of the ellipse with the lowest curvature (i.e., the region near the minor axis of the ellipse), including this region in the trading curve allows one to model gradual price movements. However, if an ellipse is oriented at 0° (i.e., the major axis is parallel to the y-axis) or 90° (i.e., the major axis is parallel to the x-axis) as in the configuration adopted by Wang 2021, the trading price at the region with the lowest curvature would approach zero or infinity, thus rendering this region practically unusable.

Second, if the ellipse adopts configurations other than the limited cases where the sine and cosine terms can be expressed exactly (e.g., the ellipse being oriented at angles other than exactly 0° or 90°), the CEMM described by Wang will produce exploitable rounding errors when executing large volume or large value transactions. To be robust, an AMM needs to be able to handle assets valued on the order of at least billions of dollars. From a technical perspective, equations that are based on a rotated shape (e.g., an ellipse) usually involve having sine and cosine terms of the rotational angle. When the ellipse is oriented at 0° or 90° (as with the configurations adopted by Wang), the sine and cosine terms resolve to 0 and 1, thus simplifying the computations and avoiding many computational challenges faced by a CEMM with more general applicability (such as the HF-CEMM of the present disclosure, which allows the ellipse to be rotated to any angle between 0° and 90°). For nearly all other rotational angles, however, the sine and cosine terms would produce irrational numbers, which cannot be represented exactly by computers. Ordinarily, fixed point arithmetic operations on computers are precise to the eighteenth decimal place. However, in ellipse calculations, when the sine and cosine terms need to be multiplied by the square of balances, any rounding error is propagated from the eighteenth decimal place to non-negligible decimal places. Furthermore, as previously described in the background section, Wang 2021 described fitting the ellipse to parameters by scaling the size of the ellipse, which further amplifies any preexisting rounding errors.

As previously discussed, such errors are particularly problematic for an AMM that must be able to yield precise calculations for transactions on the order of billions of dollars. An obvious mathematical solution would be to use more than eighteen decimals for the fixed point numbers, but in a computer environment, this could lead to multiplication overflow. Alternatively, using real world computing systems, a program could “simulate” numerical values with more space using a custom program structure that operates on multiple fixed-size numerical values at the same time, but ubiquitous application of this approach would increase the program's memory usage and degrade performance.

The present disclosure recognized the above-described problems. The proposed high-flexibility CEMM allows the ellipse to be fitted to initialization parameters with a greater degree of freedom and computes transactions with a high degree of accuracy that is able to securely conduct large volume and large value transactions. Furthermore, the proposed HF-CEMM achieves this in a computationally efficient way. It should be noted that, another advantage of the HF-CEMM is that, the computations described herein can be performed in a distributed environment such as on a blockchain, but can also be completely or partially performed off chain. By pre-computing certain values off chain, the HF-CEMM is able to conserve computational resources expended on-chain and save on-chain memory. According to some implementations, the fitting of the ellipse curve and the matching (i.e., transaction) on the trading curve need to be solved under the computational constraints of a blockchain environment. Additional details on this process can be found in the description of U.S. application Ser. No. 17/738,319, entitled “Systems and Methods for Reconstructing and Computing Dynamic Piecewise Function on Distributed Consensus System.” Specifically, according to some implementations of the present disclosure, only fixed-point numbers with a limited number of bits can be used and tight performance constraints must apply.

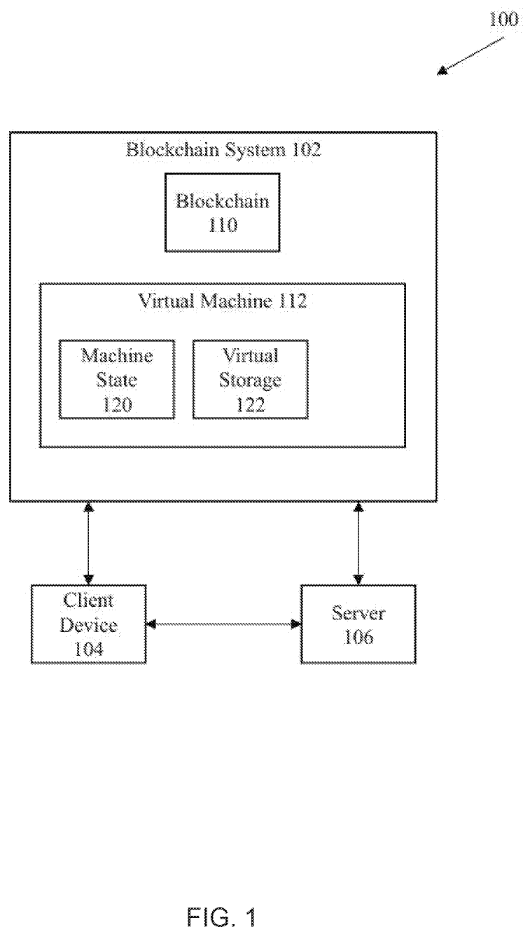

FIG. 1 illustrates a system 100 for performing computation in a distributed environment, according to some implementations of the present disclosure. The system 100 includes a blockchain system 102, a client device 104, and optionally, a server 106. The blockchain system 102 is provided as an example of a distributed peer-to-peer system, but other peer-to-peer systems are envisioned.

The client device 104 is any computing system or computing device used by a user to access services provided by the blockchain system 102 and/or the server 106. In some implementations, the client device 104 is a device used by the user (e.g., a programmer) to write programs to be deployed in the blockchain system 102. In some implementations, the client device 104 is a device used by the user to access resources or initiate transactions on the blockchain system 102. In some implementations, the client device 104 is a device used by the user to access resources provided by the server 106. For example, the client device 104 can access a programming environment (e.g., an integrated development environment) hosted by the server 106. Examples of the client device 104 include a desktop, a laptop, a computer server, a smartphone, a cold wallet, a hot wallet, etc. The server 106 can be a remote server (e.g., a cloud server), a local server, etc. Each of the client device 104 and the server 106 can include one or more processors, memory modules, storage devices, etc., to implement functions described herein.

The blockchain system 102 includes one or more computing devices referred to as nodes. There are different types of nodes, for example, a full node or a partial node. Each node includes at least one processor, at least one memory module, and at least one storage device. The blockchain system 102 functions as a distributed database such that each of the full nodes in the blockchain system 102 includes a full copy of information stored in the distributed database. Accordingly, full nodes tend to emphasize storage requirements over processing requirements. On the other hand, some nodes in the blockchain system 102 can be processor intensive. These processor intensive nodes can be referred to as miners which are incentivized to perform transactions on the blockchain (i.e., blockchain 110). The nodes of the blockchain system 102 are peers in the peer-to-peer computing network. The nodes here are described as physical computing systems underlying the infrastructure of the blockchain system 102.

In some implementations, the blockchain 110 is a public ledger (public database) that is organized as a linked list. Each of the items linked together to form the linked list is called a block. The nodes of the blockchain determine whether or not to add a new block to the linked list (i.e., the blockchain). Since the blockchain 110 is a distributed database, a consensus algorithm is used by the nodes to determine whether the new block should be added to the blockchain 110. In some implementations, a majority of the nodes are required to reach consensus, and in some implementations, all nodes should unanimously approve the new block. The blockchain system 102 uses cryptography and digital signatures to ensure confidentiality and authentication on the blockchain 110. The blockchain system 102 uses hashing to verify information within the blockchain 110 has not been compromised.

In addition to the consensus algorithm, the blockchain system 102 can include other software that underlie the rules of how the blockchain system 102 operates. In some implementations, the blockchain system 102 includes a virtual machine layer (i.e., virtual machine 112) which can provide a virtual machine environment for programmers or developers to build distributed services and/or software for the blockchain 110. The virtual machine 112 includes a machine state 120 and a virtual storage 122. The machine state 120 can be a stack machine that executes one transaction at a time, with each transaction stored in the stack. The machine state 120 maintains a state transition function for the virtual machine 112. The virtual storage 122 is a virtual memory that facilitates performing calculations for determining states of the virtual machine 112. The virtual storage 122 can store smart contracts that have been submitted by the client device 104. A smart contract is a computer program that automatically executes or documents relevant events. The smart contracts can be stored in bytecode. In some implementations, the blockchain system 102 is the Ethereum blockchain and the virtual machine 112 is the Ethereum Virtual Machine.

In some implementations, the server 106 is a cloud server. The cloud server may have a stack that includes a network layer, a data layer, and an application layer. The network layer is responsible for identifying trusted computing systems that are part of the cloud server. The data layer is responsible for data transport and formatting within the cloud server. The application layer is responsible for virtual machine and/or application instantiations. The client device 104 is able to communicate with the server 106, write programs that run on the server 106, and even write smart contracts to be deployed on the blockchain system 102 on the server 106. The server 106 can include storage for storing information remotely, for example, storing smart contracts in a native language such as bytecode (i.e., compiled/machine/binary code). The cloud server is different from the blockchain system 102 in that the blockchain system 102 includes another layer in the stack, a consensus layer. The consensus layer is responsible for consensus algorithm used to determine which nodes in the blockchain system 102 to trust for a specific transaction performed on the blockchain system 102. Furthermore, since transactions must be propagated throughout the blockchain system 102, and in some instances, the number of peers in the blockchain system 102 changes over time, performing continuous computations can be prohibitive. Embodiments of the present disclosure provide systems and methods for alleviating some drawbacks associated with inability to perform continuous computations.

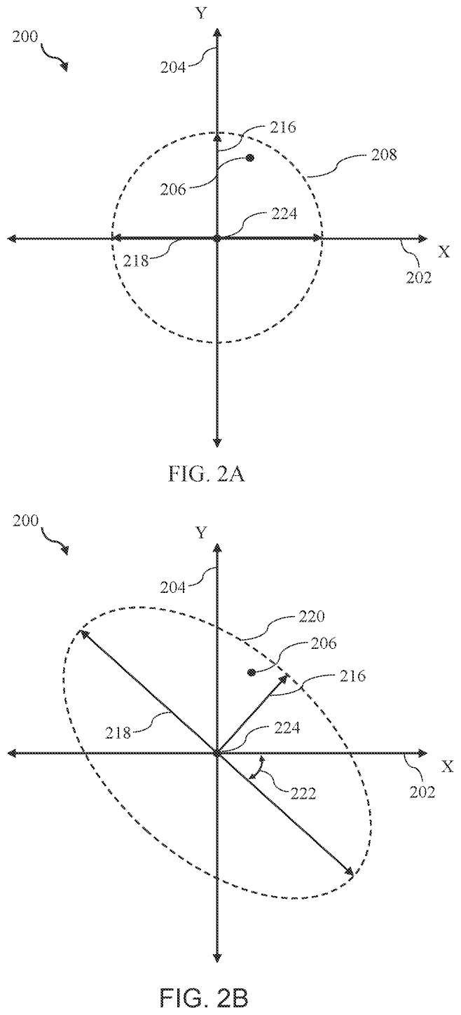

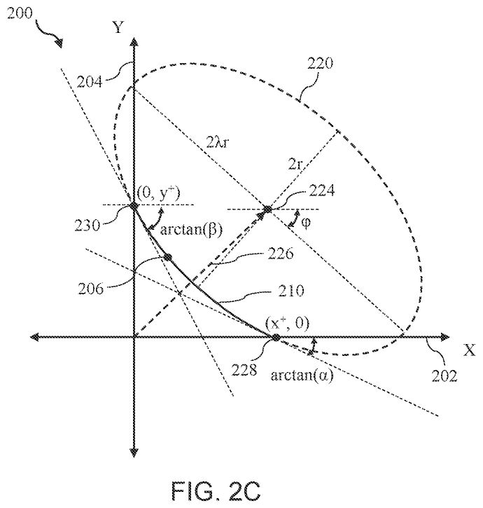

FIGS. 2A through 2C generally depict an exemplary process for constructing and fitting an ellipse based on the one or more initialization parameters. Specifically, the deformation of a circle to a fitted ellipse by one or more affine transformations and calculating a radius for the circle.

Embodiments of the present disclosure provide a high-flexibility constant ellipse market maker (i.e., HF-CEMM) for a pool having reserves of two or more asset classes. In the HF-CEMM, trading takes place along a trading curve that coincides with an arc of an ellipse, wherein the arc is defined by two bounding points along the ellipse. The HF-CEMM allows an agent (i.e., a user) to trade one asset class for another asset class along the trading curve—that is, an agent can swap an amount of a first asset class (“X”) for a certain amount of a second asset class (“Y”), or vice versa. For example, the HF-CEMM initially has a reserve state (x, y) along the trading curve. When the HF-CEMM receives a transaction request from a user who offers to sell an amount Δx of the first asset class to the system. The HF-CEMM computes an amount Δy of the second asset class based on a set of equations described in the present disclosure. If fulfilling the transaction request would result in a new reserve state (x+Δx, y−Δy) being a point coinciding with the trading curve, then HF-CEMM completes the transaction by disbursing said amount Δy of the second asset class to the user in exchanged for the offered amount Δx of the first asset class.

Mathematically, the ellipse is represented as a shifted deformation (e.g., affine transformation) of a circle. According to an implementation of the present disclosure, one or more initialization parameters are provided to the HF-CEMM. Based on the initialization parameters, one or more fitting parameters and the radius of the circle are calculated to transform the circle into an ellipse that satisfies the one or more initialization parameters. For example, the one or more initialization parameters can include a current reserve state t=(x, y) of the pool, wherein x and y respectively represent the current reserves of the first asset class and the second asset class. According to some embodiments, the reserve state can be stored by the HF-CEMM or read from an external source (e.g., a superordinate system), such as a Balancer v2 vault smart contract, which handles accounting of the assets. According to some other implementations, the current reserve state can be retrieved from a current block of a blockchain. Additional initialization parameters can include a lower price bound a and an upper price bound β, herein 0<α<β. The price bounds define a finite price range within which trading is possible. One way to define the price is to regard it as an exchange rate between the first asset class and the second asset class, represented by the negative slope of a tangent line of the trading curve at a given point (i.e., −dy/dx taken with respect to the trading curve). Thus, according to some implementations, the lower price bound and the upper price bound are the slopes of the tangent lines of the trading curve at points where the trading curve intersects the X and Y axes, respectively. At the lower price bound, the pool has exhausted its reserve of the second asset class and the reserve of the first asset class is at its maximum balance, hence the price of the first asset class relative to the second asset class is at its lowest. Vice versa, at the upper price bound, the price of the first asset class relative to the second asset class is at its highest. Table 1 below summarizes some initialization parameters that can be supplied to the HF-CEMM.

TABLE 1
Summary of initialization parameters for modeling the ellipse

| Parameters | Description |
|---|---|
| t = (x, y) | Current or computed reserve state |
| α | Lower price bound, wherein 0 < α |
| β | Upper price bound, wherein α < β |

As shown in FIG. 2A, a circle 208 with a center 224 on the origin is provided on a coordinate system 200 with reserves of a first asset class represented on the X-axis 202 and reserves of a second asset class represented on the Y-axis 204. The center 224 of the circle 208, the diameter 218, and the radius 216 are chosen dynamically so that (1) the ellipse passes through the current reserve state t=(x, y) 206; and (2) the prices at the X and Y intercepts are equal to α and β, respectively. It should be noted that there are several ways of defining the center, the diameter, and the radius of an ellipse. According to one implementation, the diameter is defined as the longest line that connects two points on the ellipse; the center of an ellipse is defined as the midpoint of the longest diameter; and the radius is the length of the shortest line that connects the center of the ellipse to any point of the ellipse.

According to some implementations of the present disclosure, the one or more affine transformations include at least one of a stretch, a rotation, and a shift. The degree of each type of affine transformation is determined by one or more fitting factors, including a stretch factor γ, a rotation angle φ, and a shifting vector (a, b) for offsetting a center of the ellipse. Simultaneously, the radius of the ellipse needs to be solved. It should be noted that the radius of the ellipse is invariant for a specific liquidity. However, if the liquidity changes (i.e., through the addition or removal of reserves from the pool), then the radius and the fitting parameters will need to be refitted to generate a new trading curve. According to some embodiments, the stretch factor γ is greater than or equal to 1 and the rotation angle φ is between 0 degrees and 90 degrees. According to some implementations, one or both of the stretch factor γ and the rotation angle φ are given externally as parameters to the HF-CEMM at initialization. For example, these parameters can be pre-calculated off blockchain. According to some other implementations, one or both of γ and φ are calculated by the HF-CEMM on the blockchain.

FIG. 2B shows a circle that has been deformed but not shifted. As shown the circle has been deformed into an ellipse 220 by stretching a diameter 218 of the circle by a factor of γ along the X-axis 202 before rotating it clockwise by φ degrees 222, according to some implementations. Thus, the new diameter of the ellipse can be expressed as d=2rγ. The linear part of the above-described affine transformation can be described using the following matrices, wherein, s and c respectively represent s=sin (−φ) and c=cos (−φ). Any point with s≥0, c≥0, and ||(s, c)||=1 is allowable.

$$A = ( \begin{matrix}c / λ & - s / λ \\ s & c\end{matrix} ) \qquad ( 1 )$$

$${A}^{- 1} = ( \begin{matrix}c λ & s \\ - s λ & c\end{matrix} ) \qquad ( 2 )$$

Referring now to FIG. 2C, the ellipse is offset from the origin by the shifting vector (a, b) 226. The new center of the shifted ellipse is represented by the point (a, b) 224. The intersection points (x⁺, 0) 228 and (0, y⁺) 230 represent points along the trading curve where the prices are α and β, respectively. To compute the shifting vectors a and b as well as perform the standard operations of the HF-CEMM, the state of the market maker, which is given by real reserves t=(x, y), is translated into the space of the untransformed circle to simplify the calculations. Once the computations are complete, the circle is transformed back into the space of the transformed ellipse.

To solve the shifting vectors and the intersection points, the functions (3) and (4) are used to map prices on the ellipse to the circle. Specifically, assuming that pₓ is an arbitrary number interpreted as a price on the ellipse, and eₓ and e_{y} are its unit vectors, then ζ(pₓ) represents an untransformed price (on the circle) corresponding to pₓ. Next, assuming that p^{c}ₓ is an arbitrary number interpreted as a price on the untransformed circle with an invariant radius r>0, then the untransformed normalized corresponding point for p^{c}ₓ is −η(p^{c}ₓ). The functions for ζ and η are shown below in functions (3) and (4).

$$ζ : ℝ \to ℝ where ζ ( {p}_{x} ) := - \frac{{e}_{y} \cdot {A ( - 1 , {p}_{x} )}^{T}}{{e}_{x} \cdot {A ( - 1 , {p}_{x} )}^{T}}$$

$$η : ℝ \to {ℝ}^{2} where η ( {p}_{x}^{c} ) := \frac{1}{\sqrt{1 + {( {p}_{x}^{c} )}^{2}}} ( \begin{matrix}{p}_{x}^{c} \\ 1\end{matrix} )$$

Given a price pₓ on the ellipse, functions (3) and (4) can be combined and put into function (5) to arrive at a point on the circle that is the image of the point with price pₓ before it is transformed onto the ellipse. In equation (5), τ(pₓ) can be expressed as a function of η(p^{c}ₓ) and ζ (pₓ).

τ: [symbol] → [symbol] ² where τ(pₓ):=η(ζ(pₓ)) (5)

Applying function (5), the shifting vector components a and b as well as the intercepts can be expressed using equations (6) and (7), wherein −x⁺′ and −y⁺′ correspond to the intercepts x⁺and y⁺before the ellipse is offset by the shifting vector (a, b). Thus, the intercepts x⁺and y⁺can be expressed in terms of x⁺′, y⁺′, a, and b in the forms shown in equations (8) and (9). Using equations (6) through (9), the shifting vector components a and b can be chosen so that the price bound conditions α and β are met.

(a, −y⁺′):=rA⁻¹τ(β) (6)

(−x⁺′,b):=rA⁻¹τ(α) (7)

x⁺=x⁺′+a (8)

y⁺=y⁺′+b (9)

Overall, the trading curve of the HF-CEMM follows equation (10) (i.e., the defining equation of the circle after deformation and shifting), wherein eₓ and e_{y} represent unit vectors of a given price point on the trading curve.

(eₓ·A(t−(a, b))²+(e_{y}·A(t−(a, b))²=r² (10)

Given equations (1) through (10) and the initialization parameters, including the current reserve state t=(x, y), one can solve for the fitting parameters, including the invariant radius r, the stretch factor γ, the rotation angle φ, and the offset vector (a, b) at the same time. Specifically, one can calculate the radius r by applying equations (11) and (12).

$$r = \frac{At \cdot A χ + \sqrt{{( At \cdot A χ )}^{2} - ( A χ \cdot A χ - 1 ) At \cdot At}}{A χ \cdot A χ - 1} , wherein \qquad ( 11 )$$

$$χ = ( {e}_{x} \cdot {A}^{- 1} τ ( β ) , {e}_{y} \cdot {A}^{- 1} τ ( α ) ) \qquad ( 12 )$$

Table 2 below provides a summary of the above-discussed fitting parameters. Table 3 below provides a summary of some relevant values used during the computation.

TABLE 2
Summary of fitting parameters

| Parameters | Description |
|---|---|
| λ | Stretching factor of the ellipse, wherein λ ≥ 1 |
| φ | Rotation angle of the ellipse, wherein 0° < φ < 90° |
| (a, b) | Shifting vector of the center of the ellipse |
| r | Invariant radius of the ellipse |

TABLE 3
Summary of relevant values during the computation

| Parameters | Description |
|---|---|
| s, c | Rotational point, wherein c = cos (−φ) and s = sin |
| | (−φ) |
| (a, b) | Shifting vector of the center of the shifted ellipse |
| y⁺, x⁺ | Y and X intercepts of the trading curve where the prices |
| | are α and β |
| −y⁺, −x⁺ | Positions corresponding to y⁺ and x⁺ before the ellipse |
| | is offset |
| pₓ | An arbitrary number representing a price on the ellipse |
| eₓ, e_{y} | Unit vectors of a given price point on the trading curve |
| ζ (pₓ) and pₓ^{c} | An untransformed price (on the circle) corresponding |
| | to pₓ |
| η(pₓ^{c}) | An untransformed normalized corresponding point for pₓ^{c} |
| τ(pₓ) | An untransformed normalized point corresponding to pₓ |

Once the ellipse 220 is fitted to the one or more initialization parameters, swapping between the first asset class and the second asset class can take place on a trading curve corresponding to an arc of the ellipse bounded by bounding points (0, y⁺) 230 and (x⁺, 0) 228.

When the invariant radius r and at least one of the x or y reserve amount of a reserve state is given, the other reserve amount can be computed using equations (13) and (14), wherein γ=1/γ², x′=x−a, and y′=y−b.

$$x = \frac{- sc \underline{λ} {y}^{′} - \sqrt{{s}^{2} {c}^{2} {\underline{λ}}^{2} {y}^{′2} - ( 1 - \underline{λ} {c}^{2} ) [ ( 1 - \underline{λ} {s}^{2} ) {y}^{′2} - {r}^{2} ]}}{1 - \underline{λ} {c}^{2}} + a \qquad ( 13 )$$

$$y = \frac{- sc \underline{λ} {x}^{′} - \sqrt{{s}^{2} {c}^{2} {\underline{λ}}^{2} {x}^{′2} - ( 1 - \underline{λ} {s}^{2} ) [ ( 1 - \underline{λ} {c}^{2} ) {x}^{′2} - {r}^{2} ]}}{1 - \underline{λ} {s}^{2}} + b \qquad ( 14 )$$

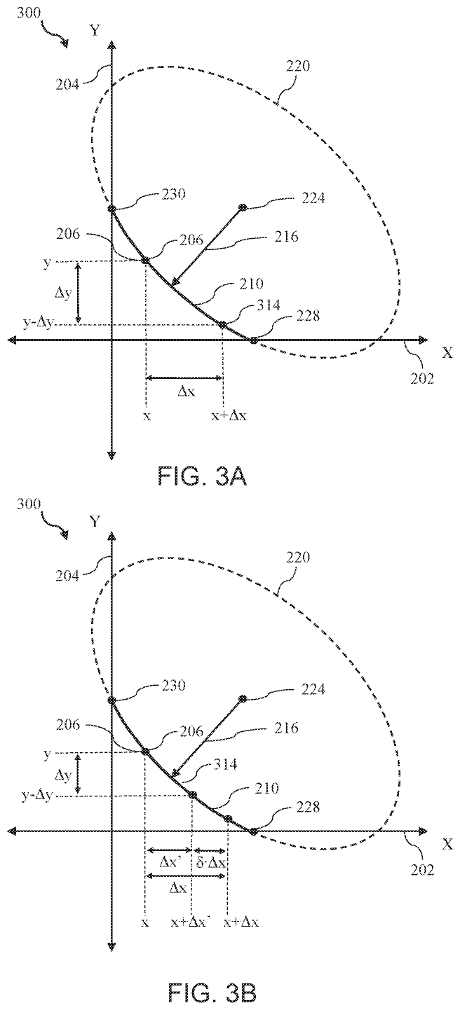

Referring to FIG. 3A, an exemplary swap using the trading curve is shown. Here, an ellipse 220 has been fitted to a set of initialization parameters including the current reserve state (x, y) 206, a lower price bound a, and an upper price bound β, with the bounding points 228 and 230 for α and β being located at (x⁺, 0) and (0, y⁺), respectively. An arc of the ellipse 220 between the bounding points (0, y⁺) 230 and (x⁺, 0) 228 is made a trading curve 210. Further, the ellipse is defined by an invariant radius r.

Initially, the reserve state of the pool is represented by the point (x, y) 206. A transaction request put to the HF-CEMM specifies at least one of Δx and Δy, wherein Δx is an offer amount of the first asset class and Δy is a disburse amount of the second asset class. Assuming that the transaction request is fulfilled, a new reserve state after the transaction can be represented by (x+Δx, y−Δy) 314. By substituting (x+Δx) and (y−Δy) for x and y in equations (13) and (14), the HF-CEMM can solve for the unknown amount (i.e., Δx or Δy, depending the transaction request). If the new reserve state (x+Δx, y−Δy) coincides with the trade curve, the HF-CEMM receives the offered amount Δx and provides disbursed amount Δy to the user. Table 1 below summarizes some of the fitting parameters that are derived based on the initialization parameters.

Note, however, the example shown in FIG. 3A shows a basic form of HF-CEMM that does not take into account value allocation to one or more second users (e.g., a protocol's governance body) or one or more third users (e.g., the liquidity providers), such as a proportion of each transaction that is allocated to a protocol in the form of a protocol fee). In the present disclosure, a protocol refers to an entity (e.g., a user or a collection of users) that administers the HF-CEMM. According to some embodiments of the present disclosure, the HF-CEMM may further include a value allocation mechanism which enables the protocol to collect fees from transactions taking place on the HF-CEMM. According to some implementations of the present disclosure, the transaction value allocation mechanism (e.g., a trading fee retained for each swap) is incorporated into the matching operation of the protocol. The amount retained can be allocated to the involved parties, such as the protocol's governance body and/or a liquidity provider.

In some implementations, the HF-CEMM provides an ellipse based on the one or more of initialization parameters, wherein an arc of the ellipse corresponds to a trading curve. The trading curve coinciding a current reserve state (x, y) of the pool, wherein x and y respectively represent a current reserve of the first asset class and the second asset class. The HF-CEMM also receives one or more allocation parameters, including a transaction retainment factor δ and a protocol retainment factor γ. FIG. 3B shows a modified HF-CEMM which allocates a portion of each transaction to the protocol and the one or more liquidity providers. When the HF-CEMM fulfills a transaction request from a first user, an offered amount Δx of a first asset class is assigned to the HF-CEMM (i.e., reserves of the first asset class increases) and a disbursed amount Δy is assigned to the first user (i.e., reserves of the second asset class decreases). In the transaction, a portion of Δx, namely, δ·Δx of the first asset class, is retained by the HF-CEMM (as a transaction fee). According to some implementations, the retained amount δ·Δx is further allocated by the HF-CEMM between the protocol's governance body and one or more liquidity providers. A portion in the amount of γ·δ·Δx is allocated by the HF-CEMM to the protocol's governance body and a portion in the amount of (1−γ)·δ·Δx is allocated by the HF-CEMM to the one or more liquidity providers. Table 3 summarizes the parameters used in allocating the transaction value.

TABLE 4
Summary of variables controlling the retainment mechanism

| Parameters | Definition |
|---|---|
| δ | Transaction retainment factor, wherein 0 ≤ δ < 1 |
| γ | Fraction of the fee received by the protocol, wherein |
| | 0 ≤ γ < 1 |
| (1 − γ) | Fraction of the fee received by one or more liquidity |
| | providers |
| Δx | Offered amount of a first asset class in a transaction |
| Δy | Disbursed amount of a second asset class in a transaction |
| Δx′ | a residual amount of Δx after a retained portion δ · Δx |
| | is deducted |

The above description outlines how transaction value is allocated in a transaction conducted on the HF-CEMM. To define how the allocated value (i.e., transaction fee) is calculated, two cases are individually analyzed and distinguished below. In the first case, the offered amount Δx of the first asset class is a known parameter. For example, the first user may have specified in the transaction request a desire to offer Δx amount of the first asset class in exchange for a yet to be determined amount of the second asset class. Based on the transaction retainment factor δ, a residual amount Δx′ of Δx after deduction of transaction fees is determined. Here, the amount Δx′ is defined as Δx·(1−δ). Executing the previously-described matching operation, the HF-CEMM computes a specific disbursement amount Δy that satisfies a matching condition such that the reserve state (x+Δx′, y−Δy) coincides with the trading curve. Responsive to an amount Δy that satisfies the matching condition being found, the HF-CEMM completes the transaction. That is, the HF-CEMM receives Δx amount of the first asset class from the first user and disburses Δy amount of the second asset class to the first user. Upon completion of the transaction, the HF-CEMM updates the current reserve state to (x+Δx′, y+Δy). If, however, the HF-CEMM does not find a Δy that satisfies the matching condition (i.e., the reserve state (x+Δx′, y−Δy) coincides with the trading curve) or that the matched Δy is a negative value, the HF-CEMM would cancel the transaction, in which case no transaction fee is paid.

In the second case, by contrast, the disbursed amount Δy of the second asset class is a known parameter. For example, the first user may have specified in the transaction request a goal of acquiring Δy amount of the second asset class by offering a yet to be determined amount of the first asset class. The HF-CEMM solves for the amount Δx that is needed in order to return a disbursed amount Δy of the second asset class. Based on the transaction retainment factor δ, the HF-CEMM performs the matching operation to solve for an amount x of the first asset class such that the reserve state (x+Δx′, y−Δy) coincides with the trading curve. The amount Δx can be solved using the equation Δx=Δx′/(1−δ). Responsive to an amount Δx that satisfies the matching condition being found, the HF-CEMM completes the transaction. That is, the HF-CEMM receives Δx amount of the first asset class from the first user and disburses Δy amount of the second asset class to the first user. Upon completion of the transaction, the HF-CEMM updates the current reserve state to (x+Δx′, y−Δy). If, however, the HF-CEMM does not find a Δx that satisfies the matching condition (i.e., the reserve state (x+Δx′, y−Δy) coincides with the trading curve) or that the matched Δy is a negative value, the HF-CEMM would cancel the transaction, in which case no transaction fee is paid.

The matching operations in the above-described cases are constructed in such a way that they mirror each other so that the same amount of assets is retained by the HF-CEMM regardless if the first user specified Δx or Δy for the transaction.

The present disclosure further introduces a mechanism for indirect allocation of fees in terms of ownership shares of the pool. According to some implementations, the fee can be allocated to one or more second users (e.g., the protocol's governance body) and one or more third users (e.g., the liquidity providers).

The HF-CEMM allocates fees to the liquidity providers implicitly because they own shares equivalent to a percentage of the reserves. As described above, retainment by the HF-CEMM increases the amount of reserves in the pool (see above). The increase in reserves in turn increases the value of ownership shares held by the liquidity providers.

The HF-CEMM allocates fees to the protocol when new ownership shares are issued and the issuance of new shares dilutes the shares held by the liquidity providers. To allocate protocol fees according to the retainment parameter γ, the HF-CEMM compares the current radius r to a previous radius r_last, which is the radius r computed in a preceding transaction. This comparison is expressed as Δr=γ·(r−r_last). According to some embodiments, a database has stored thereon an amount of ownership shares that the pool currently has outstanding. The database is communicatively linked with one or more computing devices of the HF-CEMM. Assuming that the amount of ownership shares currently outstanding is represented by S, the HF-CEMM creates an amount ΔS of new shares. The HF-CEMM assigns ownership of newly created shares ΔS to the protocol, wherein the relationship between ΔS, S, and the radii can be expressed as ΔS=S·Δr/(r−Δr). Further, HF-CEMM updates the current number of outstanding shares S with S+ΔS and stores the updated number of outstanding shares S to the database. After HF-CEMM assigns the ownership of the newly created shares ΔS to one or more second users (e.g., the protocol's governance body), the HF-CEMM unlocks the shares to allow the liquidity providers to redeem their shares for assets. This ensures that the shares are properly diluted before they are redeemed.

According to some implementations of the present disclosure, a liquidity provider who requests to join the pool (i.e., by adding to the assets to the pool) can specify a number of ownership shares desired to be received. As discussed before, the change in the amount of shares and the number of currently outstanding shares are respectively represented by ΔS and S. Based on the requested ΔS, the HF-CEMM determines an amount Δx or Δy that the liquidity provider needs to add to the pool. Here, Δx and Δy respectively represent the amount of the first asset class and the second asset class that the liquidity provider needs to add to the pool to receive the desired ΔS number of shares. Similarly, according to some implementations, a liquidity provider (including the protocol's governance body) can also redeem an amount ΔS of shares in exchange for assets in the pool (i.e., removing assets from the pool). The amount Δx or Δy that the HF-CEMM provides to the liquidity provider for the exchange can be determined using the same equations. Computationally, Δx and Δy can be solved used the following equations:

$$Δ x = x \cdot \frac{Δ S}{S} \qquad ( 15 )$$

$$Δ y = y \cdot \frac{Δ S}{S} \qquad ( 16 )$$

Upon completion of the exchange, the current number of shares S is updated by aggregating the previous current number of shares S and the change in the amount of shares ΔS.

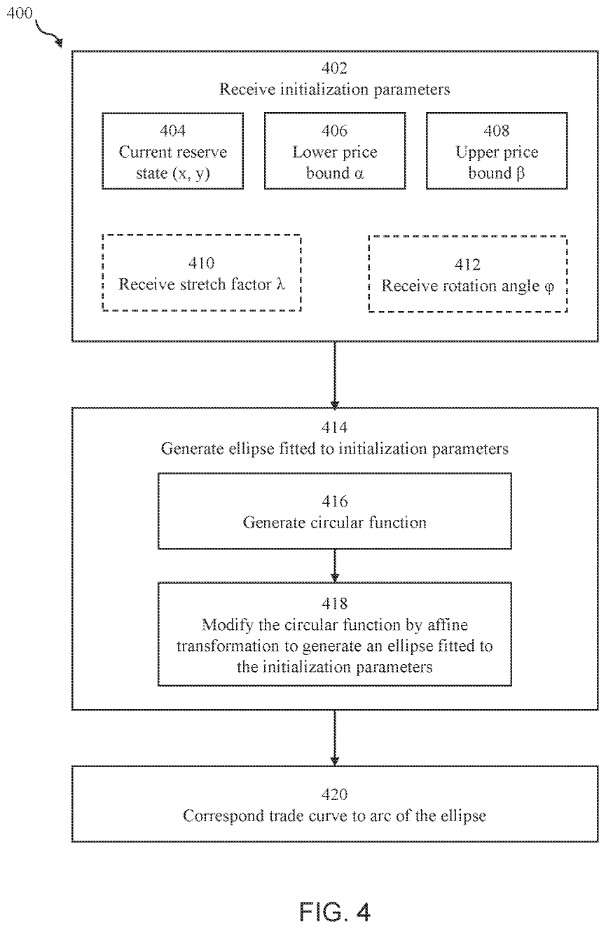

FIG. 4 is a flow diagram 400 depicting example operations for generating an ellipse fitted to one or more initialization parameters, according to some implementations of the present disclosure. The flow begins at step 402. At step 402, initialization parameters are received. For example, the initialization parameters could be received by a distributed blockchain system. Alternatively, initialization parameters could be received by a computer off-chain. The one or more initialization parameters can include a current reserve state (x, y) 404 of the pool, wherein x and y respectively represent a current reserve of the first asset class and the second asset class, a lower price bound α 406, and an upper price bound β 408. Additionally, or alternatively, the initialization parameters can include one or more preceding reserve states, according to some implementations. Furthermore, according to some implementations, along with the above initialization parameters, the HF-CEMM can also receive one or both of a stretch factor γ 410 and a rotation angle φ 412 from an external source (e.g., a user or another computing system) at the initialization.

At step 414, an ellipse fitted to the initialization parameters is generated. For example, the ellipse can be generated by a constructor program of the HF-CEMM. According to some implementations, generating the ellipse involves several sub-steps. For instance, at sub-step 416, a circular function centered on the origin of an X-Y coordinate system is generated. Next, at sub-step 418, the circular function is modified by one or more affine transformations to generate the ellipse, wherein the ellipse is fitted to the initialization parameters. According to some implementations, the one or more affine transformations include at least one of a stretch, a rotation, and a shift. The affine transformation can be based on one or more fitting parameters. According to some implementations, the fitting parameters can include a stretch factor λ, a rotation angle φ, a shifting vector (a, b), and a radius r of the ellipse. According to some implementations, the stretch factor λ is greater than or equal to 1 and the rotation angle φ is between 0 degrees and 90 degrees. As previously described, according to some implementations, instead of the HF-CEMM calculating the stretch factor λ and the rotation angle φ, these fitting parameters can be provided to the HF-CEMM from an external source as initialization parameters.

At step 420, an arc of the ellipse is designated a trading curve. For example, the HF-CEMM designates an arc of the ellipse bound by a point corresponding to the lower price bound α and a point corresponding to the upper price bound β. According to some implementations, the point corresponding to the lower price bound a coincides with an X-intercept of the trading curve, and the point corresponding to the upper price bound β coincides a Y-intercept of the trading curve. The trading curve represents reserve state of the pool. For a given reserve state along the trading curve, the price of the second asset class relative to the first asset class is represented by the negative slope of a tangent line of the trading curve at the given reserve state (i.e., −dy/dx taken with respect to the trading curve).

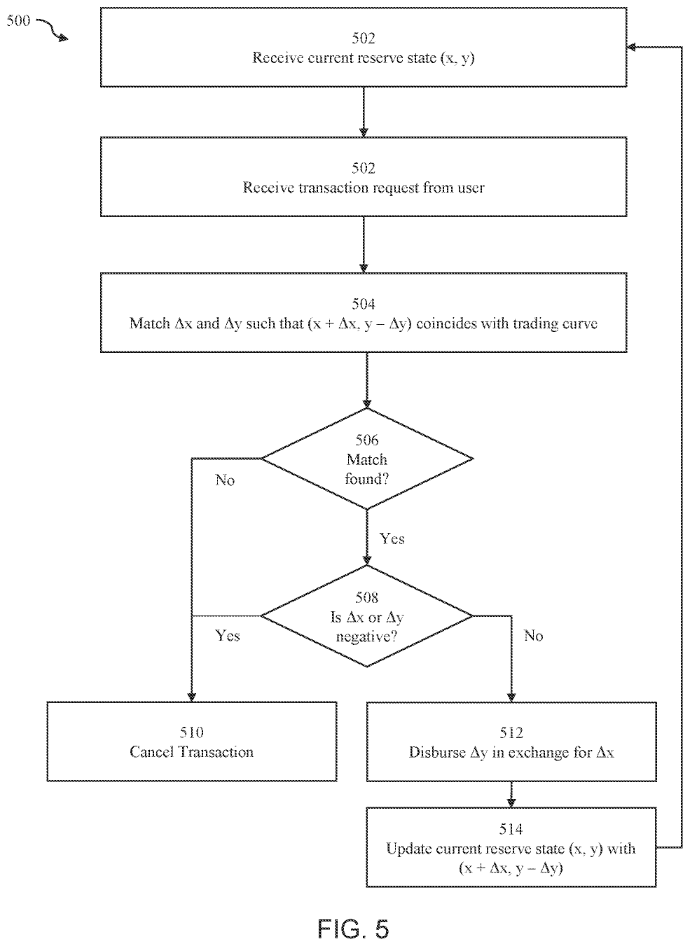

FIG. 5 is a flow diagram 500 depicting example operations for trading a first asset class for a second asset class using a trade curve, according to some implementations of the present disclosure. The flow begins at step 502. At step 502, a current reserve state (x, y) is received. For example, the current reserve state can be received by the HF-CEMM from a database. The database can be native to the HF-CEMM or be a database stored on an external source (e.g., a superordinate system), such as a Balancer v2 vault smart contract, which handles accounting of the assets. According to some implementations, the current reserve state can also be retrieved from a current block of a blockchain on a discrete distributed system.

At step 502, a transaction request is received. For example, the HF-CEMM receives a transaction request from a user via a user device (e.g., a personal computer, a smartphone, a kiosk, etc.) associated with the user. The transaction request specifies at least one of Δx and Δy, wherein Δx is an offer amount of the first asset class and Δy is a disburse amount of the second asset class. For example, the user may specify an amount of the first asset class to be traded for an unspecified amount of the second asset class, or vice versa. Alternatively, the user may specify an amount of the second asset class to be purchased with an unspecified amount of the first asset class, or vice versa. The flow continues to step 504.

At step 504, Δx and Δy are matched such that (x+Δx, y−Δy) coincides with the trading curve. For example, the HF-CEMM performs the matching operation previously described by solving the equations (13) and (14) with x+Δx replacing x and y−Δy replacing y. Once the equations have been solved, Δx and Δy can be computed. The flow continues to step 506.

At step 506, the HF-CEMM determines if a matching Δx or Δy has been found such that (x+Δx, y−Δy) coincides with the trading curve. For example, if the transaction request specified a Δy, the HF-CEMM determines if a matching Δx has been found. If found, the flow moves to step 508. If not found, the flow moves to step 510 and the transaction is canceled. Vice versa, if the transaction request specified a Δx, the HF-CEMM determines if a matching Δy has been found. If found, the flow moves to step 508. If not found, the flow moves to step 510 and the transaction is canceled. The flow continues to step 508.

At step 508, responsive to finding a matching Δx or Δy, the HF-CEMM determines if the matching Δx or Δy is a negative number. If the matching Δx or Δy is a negative number, the flow moves to step 510 and the transaction is canceled. Otherwise, the flow moves to step 512 to complete the transaction.

At step 512, responsive to the matching Δx or Δy not being negative, the transaction is completed by disbursing Δy amount of the second asset class in exchange for the offered Δx amount of the first asset class. For example, to complete the transaction, the HF-CEMM can disburse Δy amount of the second asset to the first user and receive Δx amount of the first asset in exchange, simultaneously or sequentially. After the transaction, the flow may optionally continue to step 514.

At step 514, the current reserve state is updated with the new reserve state (x+Δx, y−Δy). For example, after completion of the transaction, the new reserve state is stored by the HF-CEMM as the current reserve state for the next transaction. According to some embodiments, the new reserve state is stored as the current reserve state in a database for the next transaction. Additionally, or alternatively, the new reserve state can be stored on an external location (e.g., a superordinate system) such as a Balancer v2 vault smart contract, which handles accounting of the assets. According to some embodiments, the new reserve state can also be stored to a current block of a blockchain on a discrete distributed system, which becomes the current reserve state for the next transaction and the flow process 500 is repeated.

It should be noted that the flow process 500 describes a basic form of transaction on the HF-CEMM that does not assess trading fees. In view of descriptions in other parts of the present disclosure, it would be apparent to a person of ordinary skills in the art to modify the matching operation while taking into account a trading fee or by allocating part of the transaction value to the protocol and/or the one or more liquidity providers.

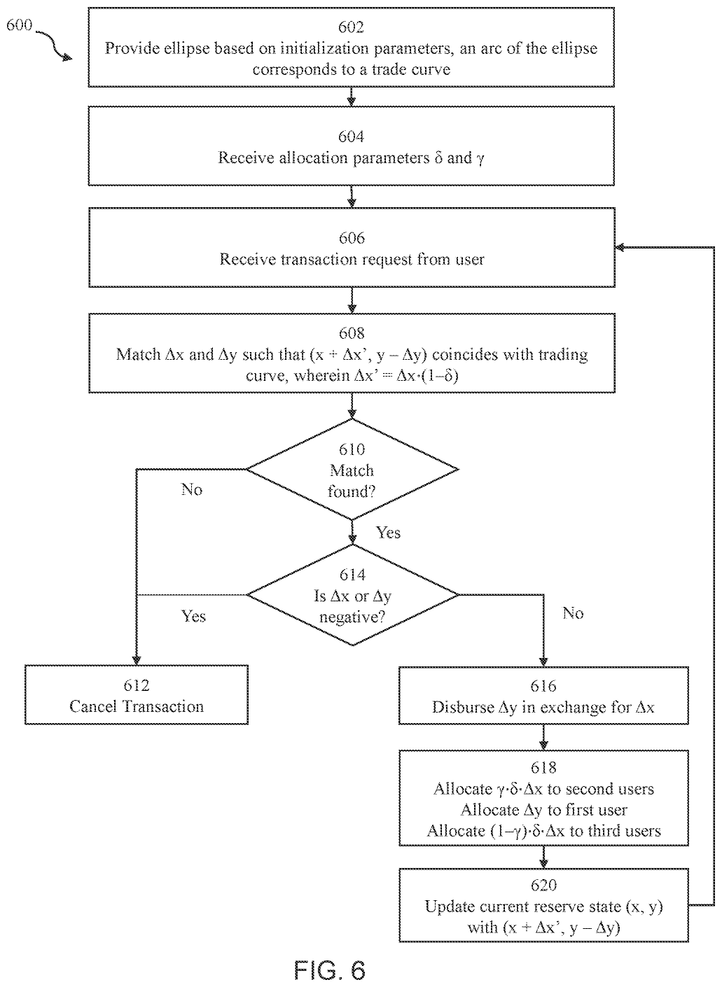

FIG. 6 is a flow diagram 600 depicting example operations of a transaction in which the matching operation takes into account allocating part of the transaction value to the protocol and the one or more liquidity providers, according to some implementations of the present disclosure. The flow begins at step 602.

At step 602, an ellipse based on a set of initialization parameters is provided. For example, the HF-CEMM can generate the ellipse using the fitting operation described in flow diagram 400. The flow continues to step 604.

At step 604, the HF-CEMM receives a transaction retainment factor δ and the protocol retainment factor γ. The transaction retainment factor δ, which is represented by a number between 0 and 1, represents a fraction of each transaction that will be retained. The fraction of each transaction that is retained is called the retained amount. The protocol retainment factor γ, which is also represented by a number between 0 and 1, represents a fraction of the retained amount that is assigned to the protocol, whereas the remainder of the retained amount is assigned to one or more liquidity providers. According to some implementations, the factors δ and γ are entered into the HF-CEMM by the protocol. The HF-CEMM can use a variety of mechanisms to set the values for δ and γ. According to some implementations, HF-CEMM sets and locks the value for δ after the pool has been created, while the value for γ updatable after initialization. According to some implementations, one or both of the factors δ and γ can be updated in the HF-CEMM after initialization. For example, according to some implementations, one or both of the factors δ and γ are automatically adjustable by the HF-CEMM according to a predefined formula. The flow continues to step 606.

At step 606, a transaction request is received. For example, the HF-CEMM receives a transaction request from a user via a user device (e.g., a personal computer, a smartphone, a kiosk, etc.) associated with the user. The transaction request specifies at least one of Δx and Δy, wherein Δx is an offer amount of the first asset class and Δy is a disburse amount of the second asset class. For example, the user may specify an amount of the first asset class to be traded for an unspecified amount of the second asset class, or vice versa. Alternatively, the user may specify an amount of the second asset class to be purchased with an unspecified amount of the first asset class, or vice versa. The flow continues to step 608.

At step 608, Δx and Δy are matched such that (x+Δx′, y−Δy) coincides with the trading curve. Here, Δx′ corresponds to a reminder of the offered amount Δx after the retained amount δ·Δx has been subtracted from the offered amount. The remainder of the offered amount of Δx′ can thus be represented by the equation Δx′=Δx(1−δ). For example, the HF-CEMM can perform the matching operation previously described by solving the equations (13) and (14) with x+Δx′ replacing x and y−Δy replacing y. Once the equations have been solved, Δx and Δy can be computed. The flow continues to step 610.

At step 610, the HF-CEMM determines if a matching Δx or Δy has been found such that (x+Δx′, y−Δy) coincides with the trading curve. For example, if the transaction request specified a Δy, the HF-CEMM determines if a matching Δx has been found. If found, the flow moves to step 614. If not found, the flow moves to step 612 and the transaction is canceled. Vice versa, if the transaction request specified a Δx, the HF-CEMM determines if a matching Δy has been found. If found, the flow moves to step 614. If not found, the flow moves to step 612 and the transaction is canceled. The flow continues to step 614.

At step 614, responsive to finding a matching Δx or Δy, the HF-CEMM determines if the matching Δx or Δy is a negative number. If the matching Δx or Δy is a negative number, the flow moves to step 612 and the transaction is canceled. Otherwise, the flow continues to step 616 to complete the transaction. Alternatively, the flow can continue to step 618 or perform steps 616 and 618 simultaneously.

At step 616, responsive to the matching Δx or Δy not being negative, the transaction is completed by disbursing Δy amount of the second asset class in exchange for the offered Δx amount of the first asset class. For example, to complete the transaction, the HF-CEMM can disburse Δy amount of the second asset to the first user and receive Δx amount of the first asset in exchange, simultaneously or sequentially. After the transaction, the flow can move to step 618. If the step 618 has already been performed or is being performed simultaneously, the flow can continue to step 620.

At step 618, the retained amount of the first asset class, which can be characterized by δ·Δx, is allocated between the protocol and the one or more liquidity providers. Given transaction retainment factor δ and the protocol retainment factor γ, the protocol receives an amount γ·δ·Δx of the first asset class and the one or more liquidity providers receive an amount Δx·(1−δ) of the first asset class. If more than one liquidity providers are involved, the amount Δx·(1−δ) is split between the liquidity providers based on the proportion of total shares that each liquidity provider possesses. After the allocation, the flow can move to step 620. Alternatively, if the step 616 has not been performed, the flow can continue to step 616.

At step 620, the current reserve state is updated with the new reserve state (x+Δx′, y−Δy). For example, after completion of the transaction, the new reserve state is stored by the HF-CEMM as the current reserve state for the next transaction. According to some embodiments, the new reserve state is stored as the current reserve state in a database for the next transaction. Additionally, or alternatively, the new reserve state can be stored on an external location (e.g., a superordinate system) such as a Balancer v2 vault smart contract, which handles accounting of the assets. According to some embodiments, the new reserve state can also be stored to a current block of a blockchain on a discrete distributed system, which becomes the current reserve state for the next transaction and the flow process 600 is repeated from step 606.

The present disclosure also discloses an algorithm which minimizes rounding error while performing the fitting and matching operations described above. As previously discussed, another advantage of the present disclosure over the prior art is that the disclosure achieves a higher degree of accuracy by: (1) methodically reordering the involved terms to minimize the amplification of numerical errors; and (2) using correction factors to compensate for numerical errors; (3) targeted use of higher-precision numbers in certain situations; and (4) computing a bound on the remaining numerical error that the computation brings about after the above error minimization steps and using these to assure desired rounding directions in the final value.

As a caveat to step (3) (i.e., targeted use of higher-precision numbers), since computer memory only allocates a fixed amount of memory for each stored number, a trade-off needs to be made between having memory available for the integer part or the fractional part of a number. This caveat also indirectly applies to step (1) (i.e., methodically reordering the involved terms) since each of the reordering and application of higher precision must be determined while taking the other step into account to ensure that overflows do not occur. If there is too little memory is allocated for storing the integer part, a calculation can overflow and the program would crash or return wrong results. On the other hand, if there is too little memory allocated for storing the fractional part, calculations can become imprecise.

Regarding step (4) (i.e., computing a bound on the remaining numerical error), the computed error bound is based on the state of the system at the time of the computation, and thus would not be a constant number. The present disclosure keeps track of errors and compensates for the errors so that final values are rounded in the right direction (i.e., a direction such that potential rounding errors cannot be exploited to drain assets from the pool).

According to some implementations, the HF-CEMM mechanism parameterizes the following values, which are passed to the mechanism once, upon initialization. Table 5 summarizes the precision level of some variables used by the HF-CEMM.

TABLE 5
Summary of normal-precision parameters

| | Precision | |
|---|---|---|
| Parameters | (Decimals) | Definition |
| 0 < α < β | 18 | Lower and upper price bounds |
| 0 < c < 1 | 18 | Rotational point, wherein c = cos (−φ) |
| | | truncated at 18 decimal places. |
| 0 < s < 1 | 18 | Rotational point, wherein s = sin (−φ) |
| | | truncated at 18 decimal places. |
| 0 ≤ δ < 1 | 18 | Transaction retainment factor |
| 0 ≤ γ < 1 | 18 | Fraction of the fee received by the protocol |

Furthermore, the mechanism can receive the derived parameters shown in Table 6 as inputs with higher-precision to limit error propagation. The parameters in Table 6 are functions of the parameters shown in Table 5. According to some implementations, the parameters shown in Table 6 are pre-computed in a separate system off-chain (e.g., on a regular personal computer), which can help conserve valuable blockchain resources for other calculations. According to some other implementations, some or all of the computations for the above parameters can be performed on-chain. To improve system performance, the parameters can be re-calculated only when the parameters change.

TABLE 6
Summary of high-precision parameters

| | Precision | |
|---|---|---|
| Parameters | (Decimals) | Definition |
| dSq | 38 | c² + s² |
| τ(α) | 38 | An untransformed normalized point |
| | | corresponding to price α |
| τ(β) | 38 | An untransformed normalized point |
| | | corresponding to price β |
| u ≤ 1 | 38 | sc(τ(β)ₓ − τ(α)ₓ) |
| v ≤ 1 | 38 | s²τ(β)_{y} + c²τ(α)_{y} |
| w ≤ 1 | 38 | sc(τ(β)_{y} − τ(α)_{y}) |
| z ≤ 1 | 38 | c²τ(β)ₓ + s²τ(α)ₓ |

Here, the parameter dSq serves as a correction factor that compensates for the limited precision of s and c, which are sine and cosine terms, respectively. If the derived parameters are computed with the appropriate rounding direction (i.e., 0≤u, v, w, z≤1), then τ(β) and τ(α) will be approximately normal vectors and dSq will be close to 1 up to the limits of 18th decimal arithmetics. Furthermore, the system requires that the parameters be chosen such that the value of A_{X}·A_{X} be above a threshold so as to ensure numerical accuracy when the ellipse is fitted (specifically, when the invariant radius r is computed).

The present disclosure further discloses an optimized ordering of computational precedence so as to minimize rounding error without significantly expanding required computational resources. As previously discussed, fitting the ellipse can be achieved by solving equations (11), wherein _{X}, A, and A⁻¹ are defined by equation (12) and matrices (1) and (2).

$$r = \frac{At \cdot A χ + \sqrt{{( At \cdot A χ )}^{2} - ( A χ \cdot A χ - 1 ) At \cdot At}}{A χ \cdot A χ - 1} , wherein \qquad ( 11 )$$

$$χ = ( {e}_{x} \cdot {A}^{- 1} τ ( β ) , {e}_{y} \cdot {A}^{- 1} τ ( α ) ) \qquad ( 12 )$$

$$A = ( \begin{matrix}c / λ & - s / λ \\ s & c\end{matrix} ) \qquad ( 1 )$$

$${A}^{- 1} = ( \begin{matrix}c λ & s \\ - s λ & c\end{matrix} ) \qquad ( 1 )$$

While the above calculation could be performed in the way it is written above, this approach (i.e., the naïve approach) would introduce exploitable rounding errors. Due to the limited memory space available for each numeric value, arithmetic operations introduce rounding errors of size le-18 and le-38 for 18-decimal precision numbers and 38-digit precision numbers, respectively. Performing the above calculations head on can lead to amplification of these values in several interacting ways. First, the vectors τ(α) and τ(β) should be computed to high precision because the rest of the procedure is sensitive to these terms. Second, computing _{X} directly requires multiplication by γ, which may be a large number and would amplify any rounding errors incurred in previous operations. Third, in the sub-operations At·A_{X}, rounding errors incurred in other operations are amplified by multiplying by the reserve balances x and y. In the operation At·At, error-prone calculations are further multiplied by the square of the balances. This operation can lead to a severe amplification of rounding errors when the balances are large.

The present disclosure minimizes the rounding errors by reordering the algorithm for the sub-operation At AX using the following mathematical identity shown in equation (17).

At·A_{X}=(cx−sy)(w/λ+z)/λ+(xλs+yλc)u+(xc+cy)v (17)

In equation 17, each of the multiplications and divisions fall into one of three categories. First, the operation multiplies an 18-decimal number by another 18-decimal number. For these operations, it holds that, if one of the inputs has an error, then the other input has no error and is bounded by a small constant value (in the example, by 2). This implies that these operations do not amplify any error in their input (i.e., they do not change the order of magnitude) and they only introduce an additional error of le-18. This is the case for the terms (cx-sy), xλ, yλ, (xλs+yλc), and (xc+cy).

Second, the operation multiplies a 38-decimal number by another 38-decimal number. For these operations it holds that both of their inputs are always bounded by a small constant value (in the example, again by 2). Therefore, errors are never amplified and the additional error is le-38. This is the case for the terms (w/γ+z)/γ.

Third, the operation multiplies an 18-decimal number by a 38-decimal number. If the 18-decimal value is of order ≤1e20, no error is amplified and the total error of the term is on the order le-18. If the 18-decimal value is of order >1e20, then it can amplify an error in the 38-decimal term. The algorithm of the present disclosure tracks the amplified errors to compensate for the error at a later step. Bounds placed on the input variables ensure that these errors stay within an acceptable range. For example, if the balances of the reserve (x, y) is on the order of trillions, an 18-decimal term could be on the order of 1e24, which would lead to error amplification in only the last 4 digits of the 18-decimal number.

Overall, the disclosed method of calculating At·A_{X} is able to keep an error on the order of le-18 as long as xλ and yλ are not extremely large. By contrast, the naïve approach would have led to a rounding error on the order of max(x, y)·1e-18.

Assuming that the parameters s and c are truncated 18-decimal places, the mechanism uses the correction factor dSq to compensate for any errors. Specifically, as shown in equation (17), the formula is a homogeneous polynomial in s and c of degree 4. Because of the homogeneity, the rounding errors can be compensated by dividing the formula by dSq^{∧}2, which can also be expressed as (√dSq))^{∧}4.

In summary, the principle behind the algorithm for achieving a high degree of numerical accuracy is to specify the computation of all the involved values in such a way that (a) the above-described conditions 1 and 2 are satisfied, if possible; (b) the power of s and c is the same even number in all summands so that the rounding error can be compensated by dividing by powers of dSq; (c) the values that are computed to very high precision are limited in size so that all operations fit into the total limited fixed-point space of 256 bits; and (d) only few high precision-derived parameters are pre-computed off the blockchain. However, it should be noted that, according to some embodiments, the parameters can also be computed on-chain, either as part of the HF-CEMM or in a separate sub-system.

It should be further noted that the above techniques for making high-precision calculations to determine the radius r with high accuracy can also be used to improve the accuracy when calculating swap exchanges.

According to some implementations, one or more of the fitting factors and relevant values can be calculated on a distributed blockchain system. However, to save on computational resources, some of the relevant values, such as r (α) and r (β), are computed once and stored for repeated use, according to some implementations. The relevant values are then passed to the functions that need them. According to some implementations, to further save computational resources and to avoid numerical inaccuracies associated with square root calculations, some of the relevant values, such as r (α) and r (β), are not computed in the smart contract, but are rather passed as inputs to the HF-CEMM and then only validated on-chain.

Embodiments of the present disclosure include various steps and operations, which have been described above. A variety of these steps and operations may be performed by hardware components or may be embodied in machine-executable instructions, which may be used to cause one or more general-purpose or special-purpose processors programmed with the instructions to perform the steps. Alternatively, the steps may be performed by a combination of hardware, software, and/or firmware.

Embodiments of the techniques introduced here may be provided as a computer program product, which may include a machine-readable medium having stored thereon non-transitory instructions which may be used to program a computer or other electronic device to perform some or all of the operations described herein. The machine-readable medium may include, but is not limited to optical disks, compact disc read-only memories (CD-ROMs), magneto-optical disks, floppy disks, ROMs, random access memories (RAMs), erasable programmable read-only memories (EPROMs), electrically erasable programmable read-only memories (EEPROMs), magnetic or optical cards, flash memory, or other type of machine-readable medium suitable for storing electronic instructions. Moreover, embodiments of the present disclosure may also be downloaded as a computer program product, wherein the program may be transferred from a remote computer to a requesting computer by way of data signals embodied in a carrier wave or other propagation medium via a communication link.

The phrases “in some embodiments,” “according to some embodiments,” “in the embodiments shown,” “in other embodiments,” “in some examples,” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting the scope of the disclosure, which is defined by the claims.

What is claimed is:

1. A system for allocating transaction value on a high-flexibility constant ellipse market maker (“HF-CEMM”) of a pool having reserves of a first asset class and a second asset class, the system including a non-transitory computer-readable medium storing computer-executable instructions thereon such that when the instructions are executed, the system is configured to:
provide an ellipse based on the one or more of initialization parameters, wherein an arc of the ellipse corresponds to a trading curve, the trading curve coinciding a current reserve state (x, y) of the pool, wherein x and y respectively represent a current reserve of the first asset class and the second asset class;
receive one or more allocation parameters including a transaction retainment factor δ and a protocol retainment factor γ;
receive, from a first user, a transaction that specifies at least one of Δx and Δy, wherein Δx is an offer amount of the first asset class and Δy is a disburse amount of the second asset class;
match a value pair for Δx and Δy such that a reserve state (x+Δx′, y−Δy) coincides with the trading curve and Δy is non-negative, wherein Δx′ is a product of Δx·(1−δ); and
responsive to determining the value pair of Δx and Δy, (a) allocate an amount γ·δ·Δx of the first asset class to one or more second users.

2. The system of claim 1, wherein the system is further configured to:
responsive to matching the value pair for Δx and Δy, (b) allocate Δy amount of the second asset class to the first user in exchange for Δx amount of the first asset class.

3. The system of claim 1, wherein the system is further configured to:
responsive to matching the value pair for Δx and Δy, (c) allocate (1−γ)·δ·Δx amount of the first asset class to one or more third users.

4. The system of claim 3, wherein the one or more third users include one or more liquidity providers, the system is further configured to:
allocate the (1−γ)·δ·Δx amount of the first asset class among the one or more liquidity providers based on a proportion of a total share of the pool held by each of the one or more liquidity providers.

5. The system of claim 1, wherein the system is further configured to:
responsive to being unable to determine the value pair for Ax and Ay such that the reserve state (x+Δx′, y−Δy) coincides with the trading curve or that Ay can only be negative value, cancel the transaction.

6. A system for implementing a high-flexibility constant ellipse market maker (“HF-CEMM”) for a pool having reserves of a first asset class and a second asset class, the system including a non-transitory computer-readable medium storing computer-executable instructions thereon such that when the instructions are executed, the system is configured to:
receive one or more initialization parameters including a current reserve state (x, y) of the pool, wherein x and y respectively represent a current reserve of the first asset class and the second asset class; and
generate an ellipse fitted to the one or more of initialization parameters, wherein an arc of the ellipse corresponds to a trading curve, the trading curve coinciding with the current reserve state (x, y).

7. The system of claim 6, wherein a price of the first asset class relative to the second asset class at a given reserve state on the trading curve correlates to a slope of the trading curve at the given reserve state.

8. The system of claim 6, wherein the one or more of initialization parameters further includes at least one of a lower price bound a and an upper price bound β, wherein 0<α<β.

9. The system of claim 8, wherein the lower price bound a corresponds to a slope of the trading curve at a first reserve state (0, y⁺), wherein y⁺ corresponds to a y-intercept.

10. The system of claim 7, wherein the lower price bound β corresponds to a slope of the trading curve at a second reserve state (x⁺, 0), wherein x⁺ corresponds an x-intercept.

11. The system of claim 6, wherein the ellipse is generated from a circular function, the circular function being modified by one or more affine transformations, the one or more affine transformations include at least one of a stretch, a rotation, and a shift.

12. The system of claim 11, wherein the ellipse is fitted to the one or more of initialization parameters by one or more affine transformations based on one or more fitting factors, the one or more affine transformations include at least one of a stretch, a rotation, and a shift.

13. The system of claim 12, wherein the one or more affine transformations are determined by at least one of a plurality of fitting factors including a stretch factor λ, a rotation angle φ, and a shifting vector (a, b) for shifting a midpoint of the circular function.

14. The system of claim 13, wherein the linear part of the affine transformation depends on a one or more fitting parameters, the one or more fitting parameters including a stretch factor λ and rotational angle φ, wherein the stretch factor λ is greater than or equal to 1 and the rotational angle φ is between 0 degrees and 90 degrees.

15. The system of claim 14, wherein the circular function has a radius r determined based on the one or more initialization parameters and at least one of the one or more fitting parameters.

16. The system of claim 15, wherein the radius r is determined using a discrete distributed system, the discrete distributed system being a blockchain system.

17. The system of claim 16, wherein the shifting vector (a, b) and the radius r are determined using the discrete distributed system simultaneously.

18. The system of claim 6, wherein the system is further configured to:
receive a transaction request that specifies at least one of Δx and Δy, wherein Δx is an offer amount of the first asset class and Δy is a disburse amount of the second asset class;
match a value pair for Δx and Δy such that a reserve state (x+Δx, y−Δy) coincides with the trading curve and Δy is non-negative; and
responsive to matching the value pair of Δx and Δy, disburse Δy amount of the second asset class in exchange for Δx amount of the first asset class.

19. The system of claim 18, wherein the system is further configured to update the current reserve state with (x+Δx, y−Δy).

20. The system of claim 18, wherein the system is further configured to:
responsive to being unable to determine the value pair for Δx and Δy such that the reserve state (x+Δx, y−Δy) coincides with the trading curve or that Δy can only be negative value, cancel the transaction.

21. The system of claim 18, wherein the value pair Ax and Ay such that the reserve state (x+Δx, y−Δy) is matched using a discrete distributed system, the discrete distributed system being a blockchain system.

22. The system of claim 6, wherein at least one of the first asset class and the second asset class is a fungible asset.

23. The system of claim 22, wherein the fungible asset includes at least one of a stablecoin, a fiat currency, an exchange-traded commodity, a blockchain token, a financial instrument, and a derivative.

24. The system of claim 6, wherein the ellipse is calculated from fixed point numbers.

25. The system of claim 6, wherein the current pool state is received from a superordinate system.

26. A method for implementing a high-flexibility constant ellipse market maker (“HF-CEMM”) of a pool having reserves of a first asset class and a second asset class, the method comprising:
receiving one or more initialization parameters including a current reserve state (x, y) of the pool, wherein x and y respectively represent a current reserve of the first asset class and the second asset class; and
generating an ellipse fitted to the one or more of initialization parameters, wherein an arc of the ellipse corresponds to a trading curve, the trading curve coinciding with the current reserve state (x, y).

27. The method of claim 26 further comprising:
receiving a transaction that specifies at least one of Δx and Δy, wherein Δx is an offer amount of the first asset class and Δy is a disburse amount of the second asset class;
matching a value pair for Δx and Δy such that a reserve state (x+Δx, y−Δy) coincides with the trading curve and Δy is non-negative; and
responsive to matching the value pair of Δx and Δy, disbursing Δy amount of the second asset class in exchange for Δx amount of the first asset class.
